(19) United States
(12) Patent Application Publication
(10) Pub. No.: US 2007/0137581 A1
(43) Pub. Date: Jun. 21, 2007

(54) Teat cup for laboratory animals

(75) Inventor: Toshio Watanabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NIHON UNIVERSITY

(21) Appl. No.: 10/576,197

(22) PCT Filed: Oct. 14, 2004
(86) PCT No.: PCT/JP04/15153

§ 371 Date: Apr. 17, 2006

(30) Foreign Application Priority Data
Oct. 30, 2003 (JP) 2003-370760

(51) Int. Cl. A01J 5/04

(52) U.S. Cl. 119/14.47

(57) ABSTRACT

An improved teat cup allows large amounts of milk to be milked from laboratory animals such as rats, mice, beagle dogs for experiment purposes, and miniature pigs directly from their teats in a short time. The inner wall surfaces are formed to conform to the shape of an udder 60 of the laboratory animal. The inner wall surfaces are dimensioned to be slightly larger than the udder 60. A conically bulging portion 62 of the udder 60 and a teat base portion 63 in particular are caused to become attached to the inner wall surfaces through a sucking negative pressure provided by a milking apparatus. The teat cup provides an effect similar to the stimulus provided by a suckling newborn, whereby oxytocin secretion from the posterior lobe of hypophysis can be effectively promoted and large amounts of milk can be collected in a short time.

### TECHNICAL FIELD

The present invention relates to a teat cup for laboratory animals for use in a milking apparatus for laboratory animals.

### BACKGROUND ART

In recent years, substances toxic to living bodies, such as environmental pollutants, carcinogenic substances, and endocrine disruptive (chemical) substances, are posing a significant global issue. There are concerns that these toxic substances may affect living bodies through breast milk or commercially sold milk. The influence these extrinsic toxic substances may have on living bodies could be clarified if it becomes possible to collect milk from laboratory animals, such as rats or mice, in a simpler way.

However, because rats, mice, and other relatively small and prolific laboratory animals have small teats and produce only small amounts of milk, no effective milking apparatuses for these animals have been proposed. For example, it is difficult to obtain the milk of rats directly from their teats, and, therefore, in locations such as laboratories, the milk is normally collected from the stomach of a newborn rat that has been fed. The milk collected from the stomach, however, could have had its milk components broken down or digested through mixing or stirring with saliva and gastric fluid, and it is questionable if such milk could be considered true milk.

In response to these needs, the present inventors had already developed an improved milking apparatus capable of milking directly from the udders of a rat or a mouse, and a teat cup therefor, and had filed an application therefor (Domestic Re-publication of PCT International Publication (“kohyo”) WO01/067064). This milking apparatus enables even a single experimenter to perform a milking operation on a laboratory animal, thereby allowing for the acquisition of universal milking data that is not subject to individual differences between experimenters.

FIG. 6 shows an example of the aforementioned apparatus. FIG. 5 shows an example of the teat cup. In this milking apparatus for laboratory animals, a test tube 10 that functions as a milk-collecting container is capped with a sealing cap 11, through which one ends of a first tube 12 and a second tube 13 are inserted into the test tube 10 in a fluid communicating fashion. On the other end of the first tube 12, a teat cup 20 is replaceably mounted, as shown in FIG. 5. The other end of the second tube 13 is connected, through a backflow preventing member 31 and a negative pressure tank 34 that functions as an accumulator, to a vacuum pump 35. The negative pressure tank 34 is maintained in a negatively pressured condition as required.

The second tube 13 includes a first branch tube 14a fitted with a pressure sensor 51. The second tube 13 further includes a second branch tube 14b on the downstream side, which is fitted with a first bidirectional electromagnetic valve 33A. By opening the first bidirectional electromagnetic valve 33A, the second branch tube 14b can be opened to the atmosphere. Downstream of the second branch tube 14b, the second tube 13 is fitted with a second bidirectional electromagnetic valve 33B. By opening the second bidirectional electromagnetic valve 33B, the second tube 13 can be placed in fluid communication with the negative pressure tank 34.

A computer 50 is connected to the pressure sensor 51, first and second electromagnetic valves 33A and 33B, and the vacuum pump 35 such that information can be transmitted among them. The computer 50 controls the input of pressure information from the pressure sensor 51 and the outputs for controlling the open/close timing of the first and second electromagnetic valves 33A and 33B and the operation of the vacuum pump 35, for example.

When milking, the vacuum pump 35 is operated with the first and second electromagnetic valves 33A and 33B closed, so as to generate a negative pressure in the negative pressure tank 34. When a predetermined pressure is established, the second electromagnetic valve 33B is opened, whereby the air in the second tube 13 is drawn into the negative pressure tank 34, producing a predetermined negative pressure (set pressure) relative to the atmospheric pressure. At this point, the second electromagnetic valve 33B is closed, whereby the set negative pressure condition is established and maintained in the second tube 13, causing the teat cup 20 to start sucking. After this condition is maintained for a certain period of time, the first electromagnetic valve 33A is opened, whereby the inside of the second tube 13 is opened to the atmosphere and the pressure returns to the atmospheric pressure. After this condition is maintained for a certain period of time, the first electromagnetic valve 33A is closed and the second electromagnetic valve 33B is again opened. Thereafter, this cycle is repeated a set number of times, whereby the negative pressure and the atmospheric pressure are alternately provided at the tip of the teat cup 20 and a required milking operation is carried out.

The teat cup 20 is made of soft rubber (such as silicon rubber) and formed generally in the shape of a cylinder with an internal diameter d of approximately 4 mm, an external diameter D of approximately 7 mm, and a height h of approximately 4 mm. The tip of the teat cup 20 is closed with a top surface portion (liner) 21a. In the present example, the tip of the first tube 12 having an inclined surface 12a at the tip thereof is inserted into an outer-fitting portion 21b of the teat cup 20, as shown in the drawings. The top surface portion 21a of the teat cup 20, which is the liner with which the udder of a mother rat comes into contact, has a thickness b of approximately 0.4 mm. In the center of the liner, there is formed a conically shaped insertion opening 22 having a diameter c1 of approximately 1.8 mm at the tip and a diameter c2 of approximately 1.5 mm at the rear end.

During the milking period (ultimate vacuum period, or suction period), the insertion opening 22 in the top surface portion (liner) 21a of the teat cup 20 widely opens, as shown by the phantom line in FIG. 5, allowing milk to be sucked from the teat. The sucked milk is stored in the test tube 10 via the first tube 12. During the rest period (ultimate atmospheric pressure period, or atmospheric pressure/massage period, when no negative pressure is present), the insertion opening 22 formed in the top surface portion 21a becomes smaller by its own resilience and closed (i.e., returned back to its original position shown by the solid line in FIG. 5).

By using the teat cup as described above, it becomes possible to milk directly from the udder of relatively small and prolific laboratory animals, such as rats or mice. Thus, the foregoing milking apparatus provides a useful means for shedding light on the influence of extrinsic toxic substances on the living bodies through milk.

Patent Document 1: Domestic Re-publication of PCT International Publication (“saikohyo”) WO01/067064

### DISCLOSURE OF THE INVENTION

### Problem to be Solved by the Invention

The inventors milked rats, mice, and beagle dogs for experiment purposes and miniature pigs many times using the above-described milking apparatus and teat cup, and obtained good results. Through the milking procedures, the inventors experimentally confirmed that greater amounts of milk can be acquired in a shorter time by devising the shape of the teat cup in consideration of its relationship with the teat of the udder of the laboratory animals involved.

The inventors also experienced some cases in which the amount of acquired milk became extremely small depending on the individual who conducted the experiment, even though the milking was performed under substantially identical conditions. The inventors' analysis of the cause showed that the teat could be bent when the teat cup is attached to the teat of the laboratory animal, as shown in FIG. 4. Specifically, when the teat cup is shaped as shown in FIG. 5, mainly a teat 64 of an udder 60 alone is sucked into the cylindrical first tube 12 during milking. As a result, a teat tip portion 65 could be bent depending on the skill of the operator, resulting in the decrease in the amount milked and the increase in milking time.

It is therefore an object of the invention to provide an improved teat cup for laboratory animals capable of milking greater amounts of milk from the teat of the udder of a laboratory animal in a shorter time, without individual differences between the operators.

### Means for Solving the Problem

The invention provides a teat cup for laboratory animals, wherein one side of the teat cup is attached to the udder of a laboratory animal through suction and the other side of the teat cup is connected to a negative-pressure generating source via a milk collecting container, wherein milk is collected from the laboratory animal into the milk collecting container through the sucking pulsation provided by the negative-pressure generating source, the teat cup comprising:

a first conical portion where an udder base portion becomes attached;

a second conical portion where a conically bulging portion of the udder becomes attached, the second conical portion being continuous from the first conical portion;

a third conical portion where a teat base portion becomes attached, the third conical portion being continuous from the second conical portion;

a cylindrical teat holding portion where the teat is introduced by suction and fixed without blocking the teat orifice, the teat holding portion being continuous from the third conical portion; and

a connecting portion via which the cylindrical teat holding portion is connected to the milk collecting container, which is connected on the side of the negative-pressure generating source,

wherein the second conical portion, the third conical portion, and the teat holding portion are dimensioned slightly larger than the actual sizes of the conically bulging portion of the udder, the teat base portion, and the teat of the laboratory animal to be milked.

The teat cup for laboratory animal according to the invention is based on the following knowledge gained by the inventors through experiments and analysis. Namely, rats and mice have false teats and, as shown at the left of FIG. 1a, the teat 64 is normally buried in a circular bulging layer (to be hereafter referred to as “a conically bulging portion 62 of the udder”) surrounding it except during feeding or milking. Upon milking, the teat 64 is pulled out by the sucking negative pressure provided by the milking apparatus, as shown at the right of FIG. 1a. During milking, the teat base portion 61, the conically bulging portion 62 of the udder, the teat base portion 63 at the root of the conically bulging portion 62 of the udder and the teat 64, and the teat 64 are property sucked by the sucking negative pressure from the milking apparatus, such that an effect similar to the stimulus provided by the suckling newborn is provided particularly at the conically bulging portion 62 of the udder and the teat base portion 63 in association with the sucking pulsation from the milking apparatus. As a result, oxytocin secretion from the posterior lobe of hypophysis, which is believed to be indispensable to the secretion of milk, can be effectively promoted. The principle was substantially similarly applicable to laboratory animals whose teats are exposed at all times, such as beagle dogs and miniature pigs.

Thus, the teat cup of the invention includes a first, a second, and a third conical portions where the teat base portion, the conically bulging portion of the udder, and the teat base portion become attached, respectively, and it also includes the teat holding portion corresponding to the teat. A sucking pulsation provided by the milking apparatus is transmitted to these portions. The second conical portion, the third conical portion, and the teat holding portion are dimensioned to be slightly larger than the conically bulging portion of the udder, the teat base portion, and the teat of the laboratory animal to be milked, so that a slight gap is formed between each portion and the corresponding inner wall surfaces in the absence of suction. During suction, these portions become attached to the internal wall surfaces. Thus, an effect similar to the stimulus provided by a suckling newborn can be provided at the conically bulging portion of the udder and the teat base portion in particular, whereby oxytocin secretion from the posterior lobe of hypophysis can be effectively promoted and a large amount of milk can be milked in a short time.

In the teat cup for laboratory animals according to the invention, it is effective to provide the teat holding portion with a region with an increased cross-sectional area near where the tip of the teat of the laboratory animal to be milked is to be located. As mentioned above, in the case of the false teats of the rats or mice, there is only one teat orifice at the tip of the teat. The ducts from the milk gland initially gather at the mammary cistern (lactiferous sinus) where they open, and the cistern is then connected to the teat orifice through the teat canal. The teat of such laboratory animals is narrow and soft, so that when it is pulled out by the sucking negative pressure from the milking apparatus, the tip of the teat could be bent, as shown in FIG. 4, if the operator is not sufficiently skilled. The aforementioned region with an increased cross-sectional area is provided so as to prevent such bending of the teat, whereby variations in the amount milked due to individual differences among the operators can be effectively eliminated.

In a preferred embodiment of the teat cup for laboratory animal according to the invention, the teat holding portion includes a conical surface such that the teat holding portion becomes narrower toward the tip thereof. Beagle dogs and miniature pigs have nipples with a plurality of teat orifices that open at the tip of the teat, into which teat orifices the ducts from the mammary gland open directly. In the experiments by the inventors, in the case of such laboratory animals with nipples, the tip of the teat was not bent inside the teat holding portion when the teat cup was attached for milking. However, the inventors experienced a slight reduction in the amount milked when the teat holding portion was a cylindrical body with a constant diameter. Assuming this was due to the formation of a gap between the tip of the teat and the internal wall surfaces, the inventors conducted another experiment in which the teat holding portion was provided with a conical surface such that the teat holding portion became narrower toward the tip thereof, as mentioned above. Then, an increased amount of milk was obtained. The teat cup for laboratory animals according to the invention as described above is based on such results of experiments.

In a preferred embodiment of the teat cup for laboratory animal according to the invention, the teat cup is entirely made of a transparent material. Preferable examples of such material include transparent silicon rubber and polypropylene. Use of such transparent material allows the condition of the teat in the teat cup to be visually observed, so that any inconveniences can be dealt with more quickly. Furthermore, since such materials have high heat resistance, they can be easily subjected to high-pressure sterilization.

### EFFECTS OF THE INVENTION

The teat cup for laboratory animals according to the invention allows large amounts of milk to be milked directly from the teat of a laboratory animal such as a rat, mouse, beagle dog for experiment purposes, and miniature pig, in a short time. Use of the teat cup together with the milking apparatus described in Domestic Re-publication of PCT International Publication (“saikohyo”) WO01/067064, which has been proposed by the same inventors, will greatly contribute to the clarification of the influence of extrinsic toxic substance on living bodies through milk, for example.

### BRIEF DESCRIPTION OF THE DRAWINGS

FIG. 1a shows the udder of a rat, FIG. 1b shows an example of a teat cup for milking a rat, and FIG. 1c is a drawing for the explanation of how the rat is milked. FIG. 1d is a drawing for the explanation of how a mouse is milked, the figure corresponding to FIG. 1c.

FIG. 2 shows a perspective view (a) of a teat cup according to another embodiment, and a cross section (b) taken along line b-b of (a).

FIG. 3a is a drawing for the explanation of how a miniature pig is milked using the teat cup shown in FIG. 2. FIG. 3b is a drawing for the explanation of how a beagle dog is milked using a teat cup according to a similar embodiment. FIG. 3c shows a teat cup according to yet another similar embodiment.

FIG. 4 is a drawing for the explanation of an example of a failure when a small animal with a false teat is milked using a conventional teat cup.

FIG. 5 shows the conventional teat cup.

FIG. 6 shows a drawing for the explanation of a milking apparatus for laboratory animals proposed by the inventors, with which the teat cup according to the invention can be suitably used.

FIG. 7 shows the measurements of each part of the teat cup used in Example 1.

### EXPLANATION OF THE NUMERALS

60 . . . udder, 61 . . . udder base portion, 62 . . . conically bulging portion of udder, 63 . . . teat base portion, 64 . . . teat, 65 . . . tip of nipple, 70 . . . teat cup, 71 . . . first conical portion where the udder base portion becomes attached, 72 . . . second conical portion where the conically bulging portion of udder becomes attached, 73 . . . third conical portion where the teat base portion becomes attached, 74 . . . cylindrical teat holding portion for immobilizing the teat, 75 . . . increased-diameter region with an increased cross-sectional area into which the tip of teat is to be located, 76 . . . large-diameter portion where a tube from a milking apparatus is inserted

### BEST MODES FOR CARRYING OUT THE INVENTION

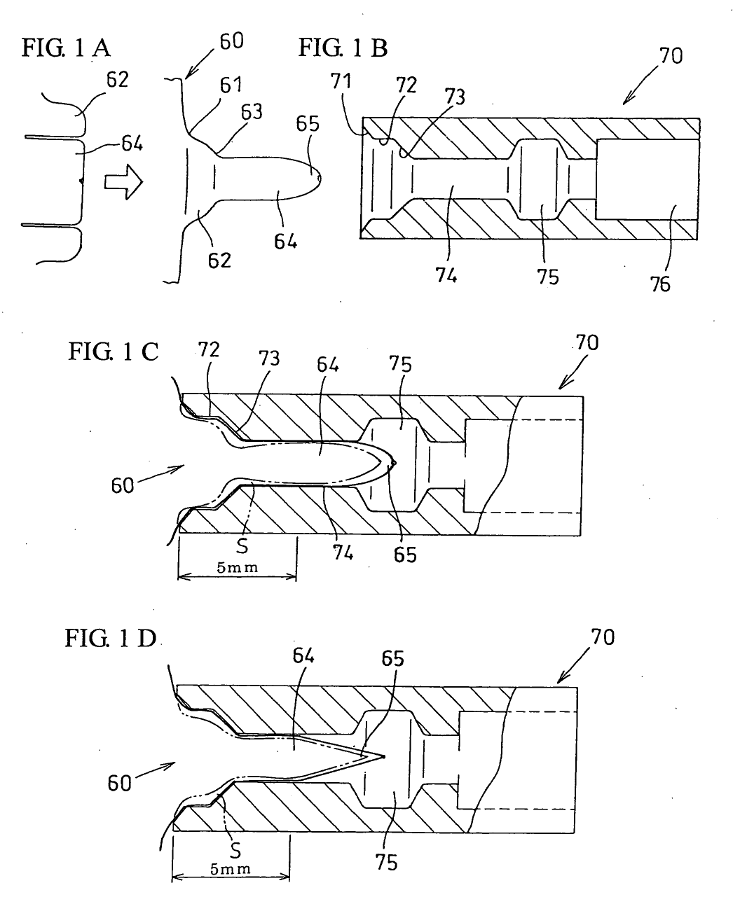

In the following, several examples of the teat cup for laboratory animals according to the invention will be described with reference to the drawings, in which FIG. 1b shows a first embodiment, and FIG. 1c shows the teat cup for laboratory animals shown in FIG. 1b being used for milking a rat.

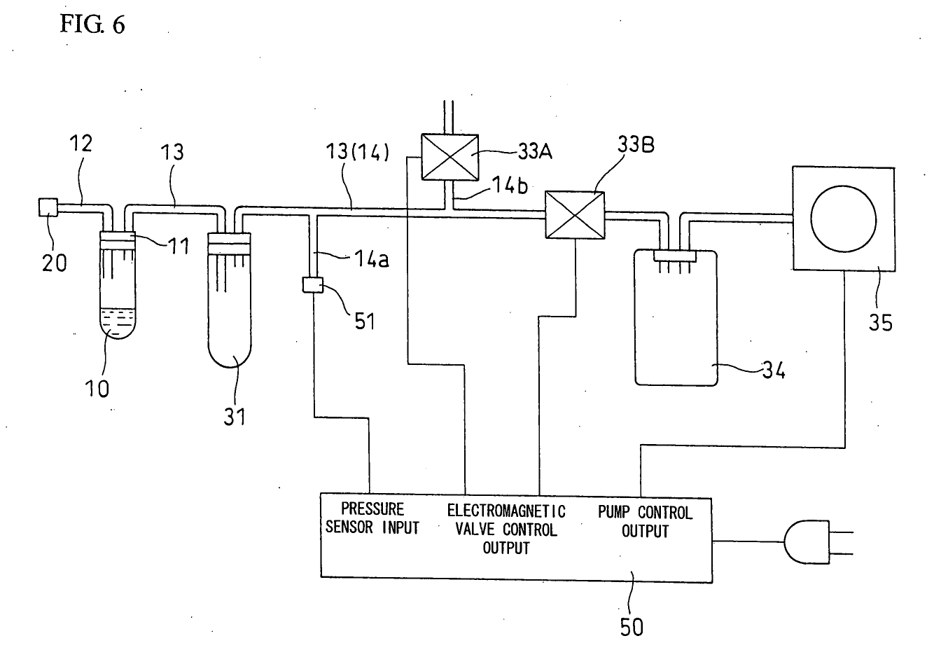

A teat cup 70 is entirely made of transparent silicon rubber. The tip of the first tube 12 of the milking apparatus described above with reference to FIG. 6 is inserted into the rear end of the teat cup 70. The apparatus shown in FIG. 6 is of course an example and the invention is not limited thereby. The teat cup 70 includes a first conical portion 71 where an udder base portion 61 of an udder 60 with a false teat of a rat, for example, is to be attached, as shown in FIG. 1a. The teat cup 70 also includes a second conical portion 72 where a conically bulging portion 62 of the udder is to be attached, and a third conical portion 73 where a teat base portion 63 is to be attached. The teat cup 70 further includes a cylindrically shaped teat holding portion 74 where the false teat 64 is introduced by suction and immobilized. The region of the first conical portion 71 constitutes a milking opening and is flexible and thinnest at the tip thereof. As the teat base portion 61 and the conically bulging portion 62 of the udder become attached to the first conical portion and the second conical portion by the sucking negative pressure of the milking apparatus, a stimulus similar to the suckling behavior of a newborn can be provided.

At the end of the teat cup opposite to the teat holding portion, a large-diameter portion 76 is formed that is of a size such that the tube 12 on the side of milking apparatus can be inserted therein. The large-diameter portion constitutes a connecting portion via which the teat cup is connected to the milk collecting container, which is connected on the side of a negative pressure source on the milking apparatus end. In the present example, the teat holding portion 74 also includes a large diameter region 75 having an increased cross-sectional area where a tip 65 of the teat 64 is to be positioned.

When milking, the false teat 64 of the rat is drawn out from the aforementioned retracted state by the negative pressure created in the teat cup 70, resulting in the state shown by the phantom line in FIG. 1c. Because of the large diameter region 75 with the larger cross-sectional area that is formed where the tip 65 of the teat 64 is positioned, the bending of the tip of the teat can be effectively prevented. Further, the second conical portion 72, the third conical portion 73, and the teat holding portion 74 are formed somewhat larger than the conically, bulging portion 62, teat base portion 63, and teat 64 that have been drawn out, so that there remains a slight gap S between them.

The activation of the negative pressure causes the udder to be enlarged as shown by the solid line in FIG. 1c, such that it becomes closely attached to the inner peripheral walls of the teat cup 70. When the pressure inside the teat cup 70 reaches the atmospheric pressure, the udder returns back to the size shown by the phantom line. This sequence is repeated as milking proceeds. As shown in an example to be described later, the teat cup 70 of the present embodiment can provide an effect similar to the suckling stimulation of a newborn to the conically bulging portion 62 of the udder and the teat base portion 63. As a result, oxytocin secretion from the posterior lobe of hypophysis can be effectively promoted, thereby enabling the collection of large amounts of milk in a short time.

FIG. 1d is similar to FIG. 1c except that the laboratory animal is a mouse. In the case of a mouse, the tip of the teat 64 is sharp; however, the condition during milking is similar to that of the case of a rat shown in FIG. 1c.

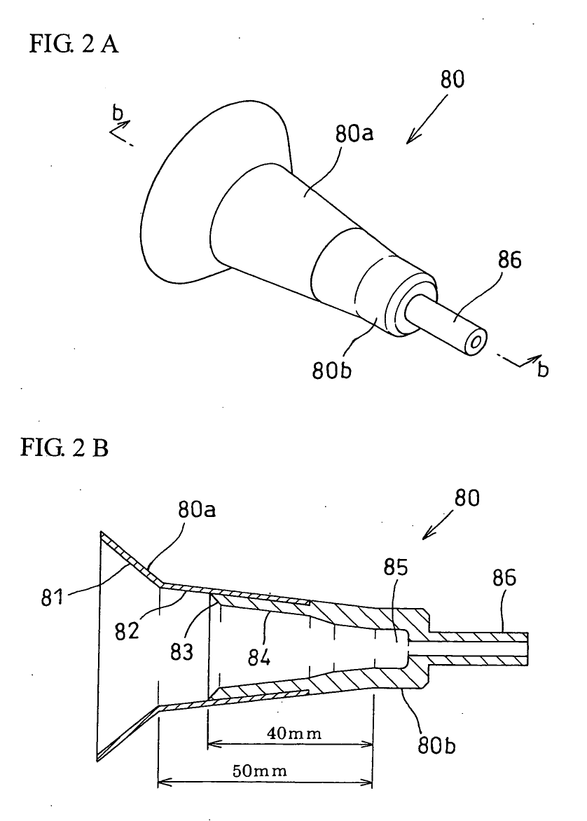

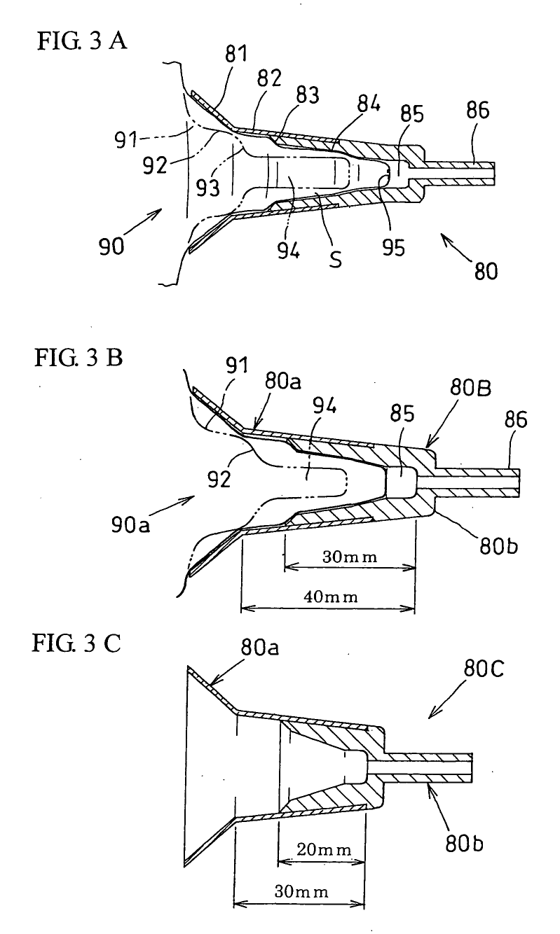

FIG. 2 shows a teat cup 80 for laboratory animals according to another embodiment. The teat cup 80 is designed for miniature pigs and is comprised of a front-end portion 80a made of polypropylene and a rear-end portion 80b made of transparent silicon rubber. The front-end portion 80a includes a first conical portion 81 where an udder base portion 91 of an udder 90 of a miniature pig having a nipple 94 (see also FIG. 3a) is to be attached, and a second conical portion 82 where a conically bulging portion 92 of the udder is to be attached. The rear-end portion 80b includes a third conical portion 83 where a teat base portion 93 is to be attached, and a teat holding portion 84 for introducing the nipple 94 by suction and immobilizing it. The teat holding portion 84 has a conical shape that gradually narrows toward the front. The entire teat cup may be made of the same material.

The teat cup includes a small-diameter portion 86 formed at the other end of the teat holding portion 84. The small-diameter portion 86, which has a diameter such that the tube 12 on the side of the milking apparatus can be fitted therein, constitutes a connection portion connecting toward the milking apparatus side. In the present example, a space 85 is provided toward the tip of the teat holding portion 84 for temporarily storing the milk sucked simultaneously from a plurality of milking openings 95.

The size of the udder 90 when the teat cup 80 is attached to the nipple 94 of the miniature pig is shown by the phantom line in FIG. 3a. As shown, in this teat cup 80, too, the second conical portion 82, the third conical portion 83, and the teat holding portion 84 are somewhat larger than the conically bulging portion 92 of the udder, the teat base portion 93, and the teat 94 of the miniature pig, with a slight gap S remaining therebetween.

As the sucking negative pressure is activated, the udder 90 is increased to the size shown by the solid line in FIG. 3a, such that it becomes closely attached to the inner peripheral walls of the teat cup 80. As in the case of the teat cup 70 previously described, the udder 90 returns to the size indicated by the phantom line when the pressure inside the teat cup 80 reaches the atmospheric pressure. This sequence is repeated as the milking operation proceeds, such that an effect similar to the suckling stimulation of a newborn can be provided to the conically bulging portion 92 and the teat base portion 93 of the udder 90, as will be described in an example below. Thus, oxytocin secretion from the posterior lobe of hypophysis can be effectively promoted, thereby enabling the collection of a large amount of milk in a short time.

FIG. 3b, which is similar to FIG. 3a, shows a teat cup 80B for beagle dogs. As shown, the length of the teat cup 80B is made somewhat shorter so as to conform to an udder 90a of a beagle dog. FIG. 3c shows a teat cup 80C that is even shorter. Thus, the size of the teat cup may be adjusted in light of the particular size of the udder of the laboratory animal.

### EXAMPLES

The invention will be hereafter described through examples.

### Example 1

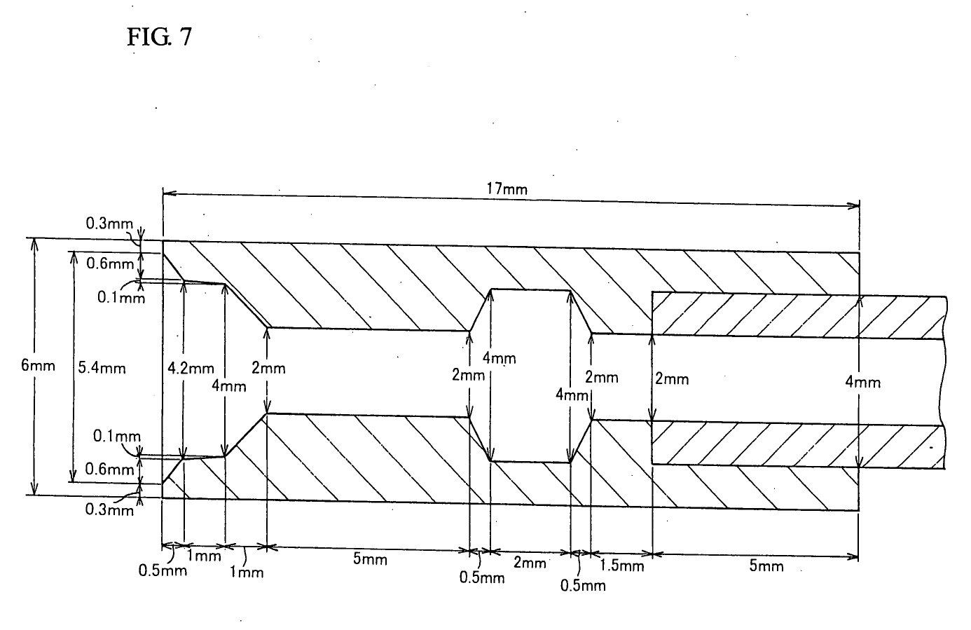

Using the teat cup 70 for laboratory animals according to the embodiment shown in FIG. 1, an SD rat and an ICR mouse were milked. The measurements of the parts of the teat cup actually used are shown in FIG. 7. The diameter of the teat 64 of a primiparous rat upon milking 14 days from birth was 1.6 mm to 1.8 mm, and its length (between the base of the teat and udder (teat base portion 63) to the tip thereof) was 5.5 mm to 6.2 mm. The tip of the teat is wedge-shaped and pointed, the teat orifice being located at the top. The diameter of the conically bulging portion 62 of the udder was 3.0 mm to 4.5 mm, and the height was 1.5 mm to 1.8 mm. The diameter of the teat 62 of a primiparous mouse upon milking on 14 days from birth was 1.5 mm to 1.8 mm constantly up to approximately the middle of its length, from which it became pointed like an arrow head. The length between the teat base portion 63 and the tip was 5.5 mm to 6.3 mm, the teat orifice being located at the top. The diameter of the conically bulging portion 62 of the udder was 3.0 mm to 4.5 mm, and its height was 1.4 mm to 1.9 mm. The areola of the rat and mouse was not visible in terms of colors to the naked eye.

Regarding the reason why the teat of rats and mice is buried within the conically bulging portion of the udder except when feeding and being milked, presumably this is to prevent the leakage of milk. Also, the burying is thought to provide the function of the areola, given the fact that milking was successful when the areas around it were stimulated through suction.

Results

Results of milking are shown in Table 1. For the purpose of uniform breeding conditions, the number of the rats and mice were adjusted to four males and four females, for a total of eight newborns four days after birth. Milking was conducted 14 days after birth when the lactation of rats and mice is at a maximum. The eight newborns were separated from their mothers at 8 a.m. on the day of milking, given a subcutaneous injection of one unit of oxytocin at 4 p.m., and then milked while the newborns were under light inhalation anesthesia with ether.

[Milking Conditions]

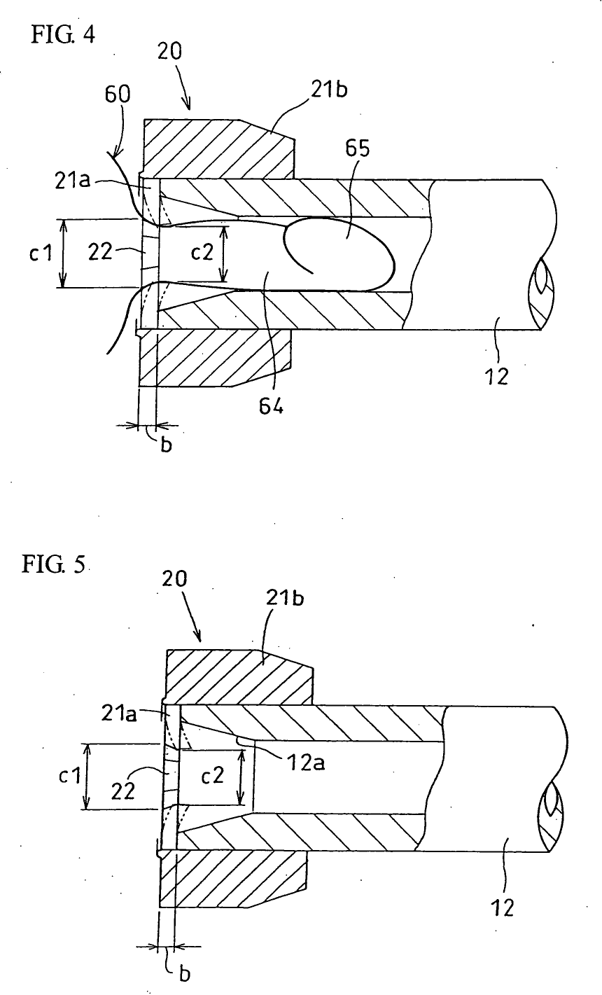

Milker: Milking device for laboratory animals (WAT-2001 from Little Leonardo) (the configuration of which was substantially identical to that of the milking apparatus described with reference to FIG. 4)
Suction pressure: −140 mmHg
Beating rate: 60/min.
Beating ratio: 60%
Amount milked: Total from all of the feeding teats

The average amount milked from the rats 14 days after birth using the new teat cup was 4.53±1.11 (3.10 to 6.92) g (number of mother rats: 10 examples). As compared with the average amount of 3.99±1.22 (2.05 to 6.21) g (number of mother rats: 15 examples) milked from the same rats using the conventional teat cup (as described with reference to FIG. 5), a clear increase was observed. Furthermore, the milking time required by the new teat cup was reduced to 30 to 40 minutes from the approximately 50 to 60 minutes required by the conventional teat cup.

TABLE 1

| | Rats: 14 days after birth | Mice: 14 days after birth |
|---|---|---|
| Number | 10 | 10 |
| of examples | | |
| Average ± standard | 4.53 ± 1.11 | 0.90 ± 0.44 |
| deviation | | |
| Range | 3.10 ± 6.92 | 0.28 ± 1.55 |

### Example 2

Using the teat cup 80 for laboratory animals according to the embodiment shown in FIGS. 2 and 3, beagle dogs for experimental purposes and miniature pigs of the pot-belly variety were milked. The diameter of the teat of a primiparous beagle dog upon milking 15 days after birth was 4.0 mm to 8.5 mm, and the length (between the base of the teat and udder (to be hereafter referred to as “a teat base portion”) and the tip thereof) was 8.0 mm to 22.0 mm. The tip of the teat was relatively flat, where the teat orifices are located. The number of teat orifices ranged from 4 to 6 per teat. The diameter of the teat of a primiparous miniature pig upon milking 20 days after birth was 3.5 mm to 10.5 mm, and the length was 8.5 mm to 28.0 mm. The tip is flat, where teat orifices are located. The number of teat orifices was normally 2 but 3 on rare occasions per teat. The areola of the beagle dogs and miniature pigs was not visible in terms of colors to the naked eye. However, given the fact that milking was made successful by stimulating the conically bulging portion from the udder to the teat base portion (to be hereafter referred to as “a conically bulging portion of the udder”) by suction, it is considered that the relevant portion is acting as the areola. The diameter of the conically bulging portion of the udder of the beagle dog was 22 mm to 35 mm, and its height was 4.0 mm to 10.0 mm. The diameter of the conically bulging portion of the udder of the miniature pig was 20 mm to 32 mm, and its height was 5.0 mm to 12.0 mm.

Using the teat cup 80 shown in FIG. 2, an experiment was conducted in which the length of the second conical portion 82 where the conically bulging portion 92 of the udder becomes attached was approximately 10 mm, the angle of inclination of the third conical portion 83 where the teat base portion 93 becomes attached was 120° to 130°, and the thickness was 2.5 mm to 4.0 mm.

In the case of beagle dogs and miniature pigs, the step formed by the third conical portion 83 where the teat base portion 93 becomes attached is important. The amount of milk collected in the absence of the third conical portion 83 was less than half that in the presence of the third conical portion 83. Also, it was particularly effective in the case of beagle dog and miniature pigs to make the second conical portion, the third conical portion, and the teat holding portion larger than the actual sizes of the conically bulging portion of the udder, the teat base portion, and the teat of the laboratory animal to be milked.

Although there were differences in the size of the udder and the teat of the beagle dogs for experiment purposes and miniature pigs to some extent, the differences were not substantial and therefore the teat cup was applicable both to beagle dogs and miniature pigs. However, differences in the size of the teats were observed in the same individual as well as in the individual dogs and pigs. Thus, several kinds of teat cups with the same structure but with different sizes were produced and used for milking.

[Results]

(1) Beagle Dog

Table 2 shows the results of milking, which was conducted four days and 15 days after birth. After the newborn was separated from the mother for 5 hours, two units of oxytocin were injected subcutaneously. Milking was initiated approximately five minutes later.

[Milking Conditions]

Milker: Milking device for laboratory animals (WAT-2001 from Little Leonardo) (the configuration of which was substantially identical to that of the milking apparatus described with reference to FIG. 4)
Suction pressure: −160 mmHg for beagle dogs
Beating rate: 60/min.
Beating ratio: 60%
Amount milked: Amount milked (g) from one teat on the right or left of the third pair from top

(Reason why milking was conducted from only one of the 10 teats making up 5 pairs: The amount milked was large. Reason why milking was conducted from one teat on the right or left of the third pair: The third and fourth pairs were visibly fullest, and the third teat from top was selected for convenience's sake. The reason why the right or left teat of the third pair was milked is that the number of the newborns of each mother dog that was milked was 4 to 7, which made it unlikely that the teats on both sides of the third pair would be necessarily used for feeding.

(2) Miniature Pig

Table 3 shows the results of milking, which was conducted 15 days after birth. After the newborn was separated from the mother for 5 hours, 2 units of oxytocin were injected subcutaneously. Milking was initiated approximately 5 minutes later.

[Milking Conditions]

Milker: Milking device for laboratory animals (WAT-2001 from Little Leonardo) (the configuration of which was substantially identical to that of the milking apparatus described with reference to FIG. 4)
Suction pressure: −180 mmHg for miniature pigs
Beating rate: 60/min.
Beating ratio: 60%
Amount milked: Amount milked (g) from one teat on the right or left of the third to fifth pairs from top

(Reasons are substantially the same as those for the dogs. It is noted, however, that the number of the teats of the pigs used was 12 to 16, namely, 6 to 8 pairs, and the number of the newborns was 4 to 6.)

TABLE 2

| | 14 days after birth | 15 days after birth |
|---|---|---|
| Number of examples | 5 | 5 |
| Average ± standard | 3.82 ± 1.56 | 12.43 ± 3.76 |
| deviation | | |
| Range | 1.85 ± 5.82 | 8.53 ± 16.74 |

TABLE 3

| | 15 days after birth |
|---|---|
| Number of examples | 2 |
| Average ± standard deviation | 8.14 ± 6.20 |
| Range | 3.75 ± 12.52 |

All publications, patents, and patent applications cited herein are incorporated herein by reference in their entirety.

1. A teat cup for laboratory animals, wherein one side of said teat cup is attached to the udder of a laboratory animal through suction and the other side of said teat cup is connected to a negative-pressure generating source via a milk collecting container, wherein milk is collected from said laboratory animal into said milk collecting container through the sucking pulsation provided by said negative-pressure generating source, said teat cup comprising:
a first conical portion where an udder base portion becomes attached;
a second conical portion where a conically bulging portion of the udder becomes attached, said second conical portion being continuous from said first conical portion;
a third conical portion where a teat base portion becomes attached, said third conical portion being continuous from said second conical portion;
a cylindrical teat holding portion where the teat is introduced by suction and fixed without blocking the teat orifice, said teat holding portion being continuous from said third conical portion; and
a connecting portion for connecting the cylindrical teat holding portion to the milk collecting container, which is connected on the side of said negative-pressure generating source,
wherein said second conical portion, said third conical portion, and said teat holding portion are dimensioned slightly larger than the actual sizes of said conically bulging portion of the udder, said teat base portion, and said teat of the laboratory animal to be milked.

2. The teat cup for laboratory animals according to claim 1, wherein said teat holding portion includes a region with an increased cross-sectional area near where the tip of the teat is to be located.

3. The teat cup for laboratory animals according to claim 1, wherein said teat holding portion comprises a conical surface that becomes narrower toward the tip thereof.

4. The teat cup for laboratory animals according to any one of claims 1 to 3, wherein said teat cup is entirely made of a transparent material.
